(19) United States
(12) Patent Application Publication
(10) Pub. No.: US 2006/0288050 A1
(43) Pub. Date: Dec. 21, 2006

(54) Method, system, and computer program product for correlating directory changes to access control modifications

(75) Inventor: David E. Wilson, Lowell, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/153,093

(22) Filed: Jun. 15, 2005

(51) Int. Cl. G06F 17/30

(52) U.S. Cl. 707/202

(57) ABSTRACT

The present invention provides a method, system, and computer program product for correlating directory changes to access control modifications. A method in accordance with an embodiment of the present invention comprises: detecting a change in a membership of a directory; determining if the detected change in the membership of the directory has modified an access control configuration of a system; and logging a modification to the access control configuration of the system that resulted from the detected change in the membership of the directory.

### BACKGROUND OF THE INVENTION

1. Field of the Invention

The present invention generally relates to access control. More particularly, the present invention provides a method, system, and computer program product for correlating directory changes to access control modifications.

2. Related Art

An access control list (ACL) is a document that tells a computer operating system which access rights a user or group of users has to a particular system resource, such as a folder or individual file. The most common privileges include the ability to read a file (or some/all files in a folder), to write to a file or files, and to execute a file (if it is an executable file, or program).

Most systems grant access to a resource to “principles” (e.g., users, groups of users, and groups of groups) listed in a directory, such as a corporate directory. When access to a resource is modified by adding/removing a user or group to/from an access control list, this event is typically logged by an access control system (e.g., “XXX has been granted access to resource YYY by ZZZ,” “XXX has been removed from the access control list of resource YYY by ZZZ,” etc.). The log can then be audited/analyzed by a security administrator for various purposes, for example to determine the security implications of the access modifications.

Another way access to a resource can be modified is via a change in the membership of a group referenced in an access control list. For example, when a new user is added to a group, the new user can now access the resources associated with that group; when an existing user is removed from a group, the removed user loses access to the resources associated with that group. Thus, when the membership of a group changes, the access control configuration effectively changes. Because group membership changes occur in an area referenced by the access control system (i.e., the directory) but independent of the access control system, the changes are not logged in a way that represent their security implications. That is, although a directory server may log that a change has been made to the membership of a group, no correlation between that change and any resultant change to the access control configuration is provided to the security administrator.

An example of the above problem is depicted in FIGS. 1-2. As shown in FIG. 1, a directory 10 includes a group 12 (Group A) that includes four users (User 1, User 2, User 3, User 4). The group 12 can comprise users having a specific security level, job type, etc. In accordance with an access control list 14, each of the users in Group A has access privileges to a resource 16. In FIG. 2, Group A has been changed (e.g., by a directory administrator 18) to include a fifth user (User 5), and this change has been logged in a log 20. However, although a security administrator 22 can determine from the log 20 that a change in the membership of Group A has occurred, the security administrator 22 is unaware of the changes in the access control configuration that occurred in response to this change in membership (i.e., User 5 now has access to resource 16).

Accordingly, there is a need for a process for relating changes in a directory (i.e., group membership changes) to modifications in access control, and for reporting such modifications as access control (security) events, if appropriate.

### SUMMARY OF THE INVENTION

In general, the present invention provides a method, system, and computer program product for correlating directory changes to access control modifications.

A first aspect of the present invention is directed to a method for correlating directory changes to access control modifications, comprising: detecting a change in a membership of a directory; determining if the detected change in the membership of the directory has modified an access control configuration of a system; and logging a modification to the access control configuration of the system that resulted from the detected change in the membership of the directory.

A second aspect of the present invention is directed to a system for correlating directory changes to access control modifications, comprising: a system for detecting a change in a membership of a directory; a system for determining if the detected change in the membership of the directory has modified an access control configuration of a system; and a system for logging a modification to the access control configuration of the system that resulted from the detected change in the membership of the directory.

A third aspect of the present invention is directed to a program product stored on a computer readable medium for correlating directory changes to access control modifications, the computer readable medium comprising program code for performing the following steps: detecting a change in a membership of a directory; determining if the detected change in the membership of the directory has modified an access control configuration of a system; and logging a modification to the access control configuration of the system that resulted from the detected change in the membership of the directory.

A fourth aspect of the present invention provides a method for deploying an application for correlating directory changes to access control modifications, comprising: providing a computer infrastructure being operable to: detect a change in a membership of a directory; determine if the detected change in the membership of the directory has modified an access control configuration of a system; and log a modification to the access control configuration of the system that resulted from the detected change in the membership of the directory.

A fifth aspect of the present invention provides computer software embodied in a propagated signal for correlating directory changes to access control modifications, the computer software comprising instructions to cause a computer system to perform the following functions: detect a change in a membership of a directory; determine if the detected change in the membership of the directory has modified an access control configuration of a system; and log a modification to the access control configuration of the system that resulted from the detected change in the membership of the directory.

### BRIEF DESCRIPTION OF THE DRAWINGS

These and other features of this invention will be more readily understood from the following detailed description of the various aspects of the invention taken in conjunction with the accompanying drawings in which:

FIGS. 1 and 2 depict an illustrative prior art system.

FIGS. 3 and 4 depict an illustrative system for correlating directory changes to access control modifications in accordance with an embodiment of the present invention.

FIG. 5 depicts a flow diagram of a method for correlating directory changes to access control modifications in accordance with an embodiment of the present invention.

FIG. 6 depicts an illustrative computer system for implementing an embodiment of the present invention.

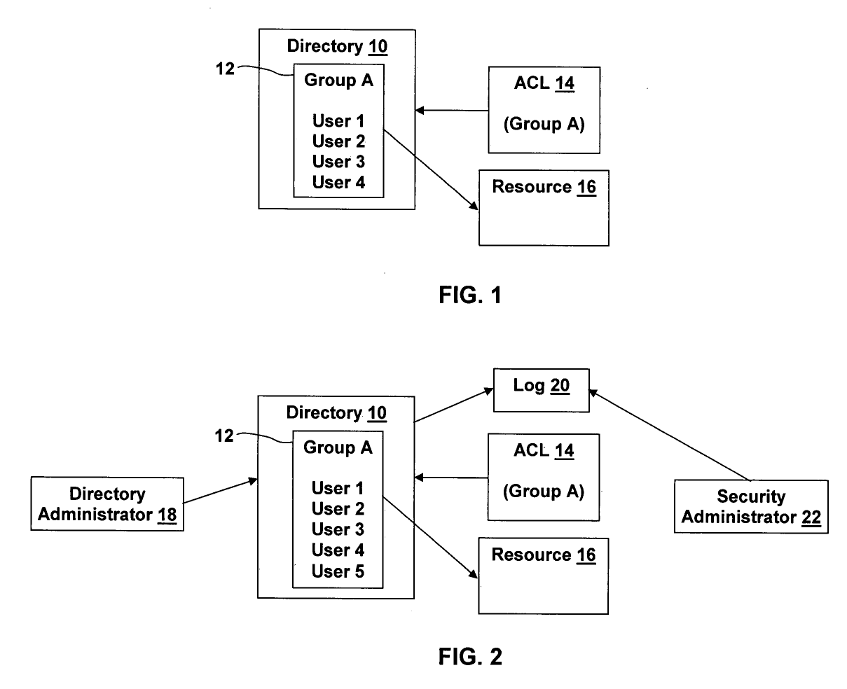

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

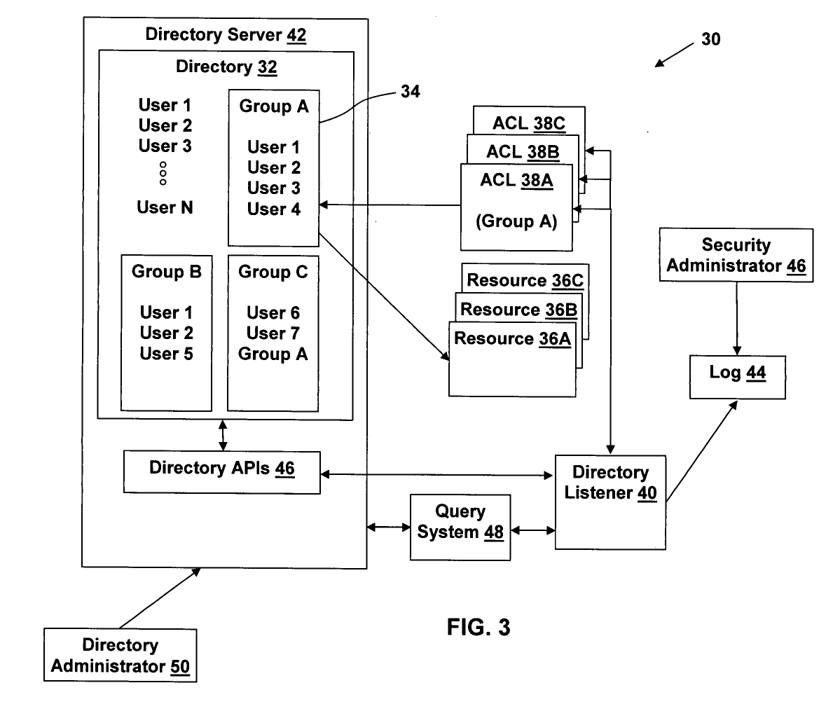

An illustrative system 30 for correlating directory changes to access control modifications in accordance with an embodiment of the present invention is depicted in FIG. 3. The system 30 includes a directory 32 that includes a plurality of users (e.g., User 1, User 2, User 3, . . . , User N) and a plurality of groups 34 (e.g., Group A, Group B, Group C). As shown, Group A includes four users (User 1, User 2, User 3, User 4), Group B includes three users (User 1, User 2, User 5), and Group C includes two users (User 6, User 7) and Group A (i.e., Group A is nested within Group C). System 30 also includes a plurality of resources 36A-C and a corresponding plurality of access control lists 38A-C, each specifying the user(s)/group(s) having access privileges to the resources 36A-C, respectively. In this example, in accordance with access control list 38A, each of the users in Group A (i.e., User 1, User 2, User 3, User 4) has access privileges to the resource 36A. It should be noted that the number of users and groups depicted in the system 30 of FIG. 3 is presented for illustrative purposes only, and is not intended to limit the present invention in any way.

In accordance with the present invention, the system 30 also includes a directory listener 40, which is coupled to the directory server 42 containing the directory 32. The directory listener 40 is configured to determine if the membership of a group 34 in the directory 32 has been changed, to determine the effect (if any) of the change in membership on the access control configuration of the system 30, and to inform a security administrator 44 of any modifications to the access control configuration of the system 30 that occurred as a result of the change in membership. The modifications to the access control configuration of the system 30 can be reported as access control (security) events in a log 44 accessible by the security administrator 46. A change in the membership of a group may comprise, for example, the addition of a user/group to the group, the deletion of a user/group from the group, the deletion of the group, etc.) The types of membership changes that initiate the reporting function of the present invention can be set by default, and/or can be determined by the security administrator 44 or other authorized individuals.

The directory listener 40 can be notified of a change in the membership of a group 34 in the directory 32 using standard directory application programming interfaces (APIs) 46 that are configured to identify and log changes in the directory 32. Alternatively, the directory listener 40 can include a query system 48 for querying the directory server 42 containing the directory 32 for group 34 membership changes that have occurred since a particular time (e.g., since the last query). Other techniques for notifying the directory listener 40 of a change in the membership of a group 34 are also possible.

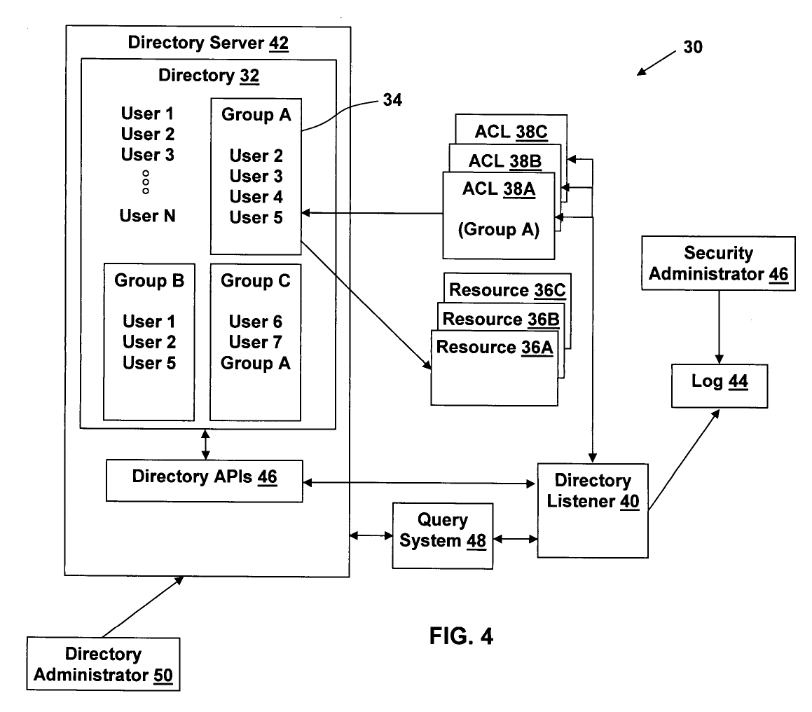

After being notified of a change in the membership of a group 34 in the directory 32, the directory listener 40 determines if the change in membership has affected the access control configuration of the system 30. For example, assume as shown in FIG. 4 that the membership of Group A has been changed (e.g., by a directory administrator 50) such that User 1 has been removed and a new user (User 5) has been added. After being informed of the change in the membership of Group A, the directory listener 40 determines which, if any, of the access control lists 38A-C provides access privileges to Group A. Since the access control list 38A provides access privileges to the members of Group A to resource 36A, and since the membership of Group A has been changed, the directory listener 40 reports the resultant modifications to the access control configuration of the system 30 as access control (security) events in the log 44. For example, the directory listener 40 can report the following changes in the log 44: “User 1 no longer has access privileges to resource 36A,” and “User 5 now has access privileges to resource 36A.” The security administrator 42 can view the modifications to the access control configuration of the system 30 by accessing the log 44.

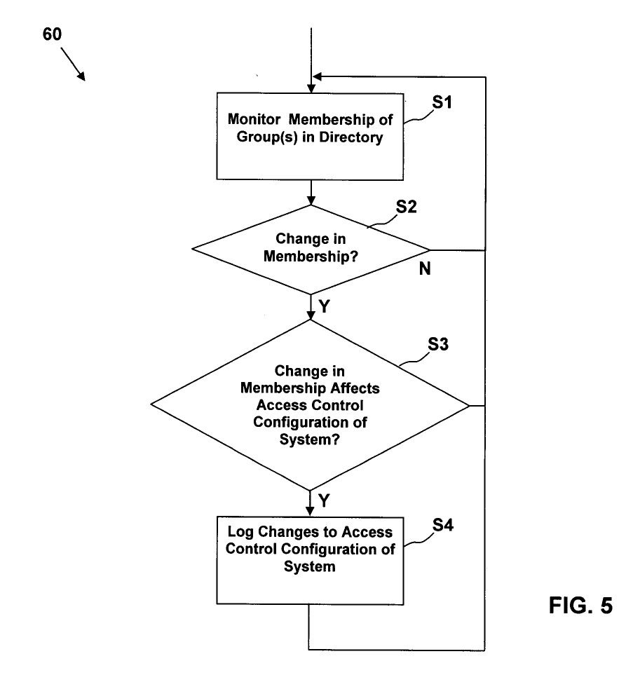

A general flow diagram 60 of a method for correlating directory changes to access control modifications in accordance with an embodiment of the present invention is depicted in FIG. 5. In step S1, a directory listener monitors the membership of the group(s) in a directory. In step S2, if a change in the membership of a group in a directory is detected by the directory listener, then flow passes to step S3. In step S3, the directory listener determines if the change in membership affects the access control configuration of the system. In step S4, the directory listener logs modifications to the access control configuration of the system that resulted from the change in membership detected in step S1.

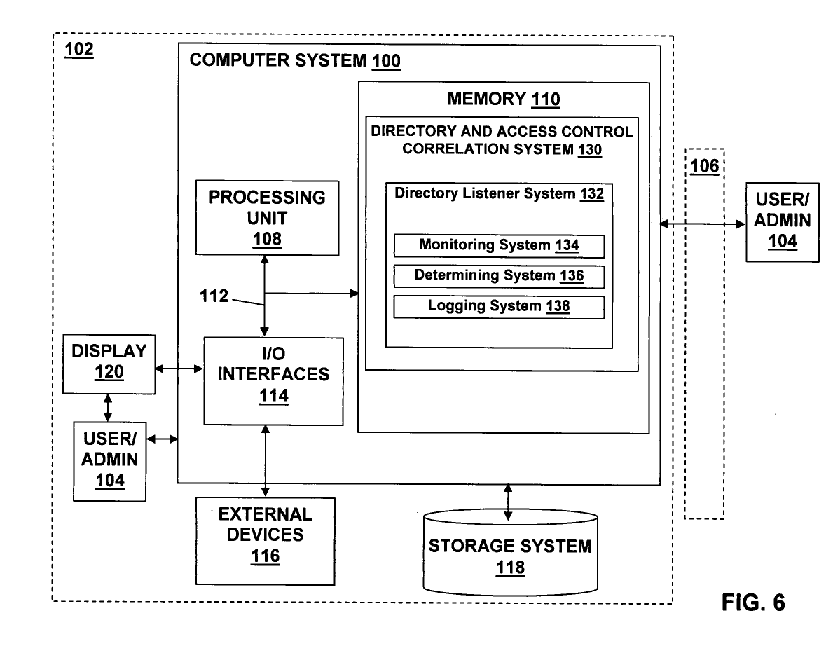

A computer system 100 for implementing a method for correlating directory changes to access control modifications in accordance with an embodiment of the present invention is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides directory and access control correlation in accordance with the present invention. It should be appreciated that a user/administrator 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as directory and access control correlation system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 5 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. Such information can include, for example, directory-related information (e.g., users, groups, etc.), access control lists, logs, etc. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user/administrator 104 can contain computerized components similar to those described above with regard to computer system 100.

Shown in memory 110 (e.g., as a computer program product) is a directory and access control correlation system 130 for correlating directory changes to access control modifications in accordance with an embodiment of the present invention. The directory and access control correlation system 130 generally includes a directory listener system 132. The directory listener system 132 includes a monitoring system 134 for monitoring the membership of the group(s) in a directory, a determining system 136 for determining if the changes identified by the monitoring system 134 have affected the access control configuration of an associated system, and a logging system 138 for logging the modifications to the access control configuration of the system.

The present invention can be offered as a business method on a subscription or fee basis. For example, one or more components of the present invention can be created, maintained, supported, and/or deployed by a service provider that offers the functions described herein for customers. That is, a service provider can be used to correlate directory changes to access control modifications, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for correlating directory changes to access control modifications, comprising:
detecting a change in a membership of a directory;
determining if the detected change in the membership of the directory has modified an access control configuration of a system; and
logging a modification to the access control configuration of the system that resulted from the detected change in the membership of the directory.

2. The method of claim 1, wherein the detecting step further comprises:
detecting a change in a membership of a group in the directory.

3. The method of claim 1, wherein the detecting step further comprises:
reporting a change in a membership of the directory to a directory listener.

4. The method of claim 1, wherein the detecting step further comprises:
querying the directory for a change in membership.

5. The method of claim 1, wherein the logging step further comprises:
logging the modification to the access control configuration as an access control event.

6. The method of claim 5, wherein the access control event comprises a security event.

7. The method of claim 1, wherein the logging step further comprises:
providing a description of the modification to the access control configuration.

8. The method of claim 7, wherein the providing step further comprises:
identifying a resource affected by the modification to the access control configuration.

9. Deploying an application for correlating directory changes to access control modifications, comprising:
providing a computer infrastructure being operable to perform the method of claim 1.

10. Computer software embodied in a propagated signal for correlating directory changes to access control modifications, the computer software comprising instructions to cause a computer system to perform the method of claim 1.

11. A system for correlating directory changes to access control modifications, comprising:
a system for detecting a change in a membership of a directory;
a system for determining if the detected change in the membership of the directory has modified an access control configuration of a system; and
a system for logging a modification to the access control configuration of the system that resulted from the detected change in the membership of the directory.

12. The system of claim 11, wherein the system for detecting further comprises:
a system for detecting a change in a membership of a group in the directory.

13. The system of claim 11, wherein the system for detecting further comprises:
a system for reporting a change in a membership of the directory to a directory listener.

14. The system of claim 11, wherein the system for detecting further comprises:
a system for querying the directory for a change in membership.

15. The system of claim 11, wherein the system for logging further comprises:
a system for logging the modification to the access control configuration as an access control event.

16. The system of claim 15, wherein the access control event comprises a security event.

17. The system of claim 11, wherein the system for logging further comprises:
a system for providing a description of the modification to the access control configuration.

18. The system of claim 17, wherein the system for providing further comprises:
a system for identifying a resource affected by the modification to the access control configuration.

19. A program product stored on a computer readable medium for correlating directory changes to access control modifications, the computer readable medium comprising program code for performing the following steps:
detecting a change in a membership of a directory;
determining if the detected change in the membership of the directory has modified an access control configuration of a system; and
logging a modification to the access control configuration of the system that resulted from the detected change in the membership of the directory.

20. The program product of claim 19, wherein the detecting step further comprises:
detecting a change in a membership of a group in the directory.

21. The program product of claim 19, wherein the detecting step further comprises:
reporting a change in a membership of the directory to a directory listener.

22. The program product of claim 19, wherein the detecting step further comprises:
querying the directory for a change in membership.

23. The program product of claim 19, wherein the logging step further comprises:
logging the modification to the access control configuration as an access control event.

24. The program product of claim 23, wherein the access control event comprises a security event.

25. The program product of claim 19, wherein the logging step further comprises:
providing a description of the modification to the access control configuration.

26. The program product of claim 25, wherein the providing step further comprises:
identifying a resource affected by the modification to the access control configuration.
